(19) United States
(12) Patent Application Publication
(10) Pub. No.: US 2026/0212665 A1
(43) Pub. Date: Jul. 23, 2026

(54) INFORMATION PROCESSING APPARATUS, INFORMATION PROCESSING METHOD, AND COMPUTER-READABLE NON-TRANSITORY STORAGE MEDIUM

(71) Applicant: Sony Semiconductor Solutions Corporation, Atsugi-shi, Kanagawa (JP)

(72) Inventors: Kohki SERIZAWA, Kanagawa (JP); Tomokazu OHMURA, Kanagawa (JP); Akitoshi ISSHIKI, Kanagawa (JP)

(73) Assignee: Sony Semiconductor Solutions Corporation, Atsugi-shi, Kanagawa (JP)

(21) Appl. No.: 19/139,376

(22) PCT Filed: Dec. 26, 2023
(86) PCT No.: PCT/JP2023/046682

§ 371 Date: Jun. 16, 2025

(30) Foreign Application Priority Data
Dec. 27, 2022 (JP) 2022-209583

(51) Int. Cl. G06V 10/98; G06V 10/12; G06V 10/774; G06V 10/94; G06V 40/10

(52) U.S. Cl. CPC G06V 10/993; G06V 10/12; G06V 10/774; G06V 10/945; G06V 40/10

(57) ABSTRACT

An information processing apparatus includes processing circuitry configured to input a target area and a distortion intensity of the target area into a trained model, wherein the target area is at least a part of a wide-angle image. Additionally, the processing circuitry is further configured to identify, based on an output of the trained model, a detection target included in the target area.

### TECHNICAL FIELD

The present disclosure relates to an information processing apparatus, an information processing method, and a computer-readable non-transitory storage medium.

### BACKGROUND ART

Known is a technique for detecting a target object such as a person using machine learning from an image captured by a camera. For example, in a case where an image is an ultra-wide-angle image such as a fisheye image, the image is captured with distortion. Therefore, in the detection of the target object using the machine learning, the target object is generally detected after the fisheye image is corrected to a planar image.

### CITATION LIST

### Patent Literature

PTL 1: Japanese Laid-open Patent Publication No. 2020-201880

### SUMMARY OF INVENTION

### Technical Problem

However, even when a fisheye image is corrected to a planar image, it may be difficult to obtain a correction effect depending on an area of the fisheye image. For example, it is easy to obtain a correction effect in a peripheral area of the fisheye image, and as such it is easy to correct the peripheral area to a clear planar image. Meanwhile, it is difficult to obtain a correction effect in a central area of the fisheye image, and as such it is difficult to correct the central area to a clear planar image.

Therefore, in a case where a target object is detected after the fisheye image is corrected to the planar image, there is a possibility that a difference occurs in the detection accuracy of the target object depending on the position of the image. This difference may occur not only in the fisheye image but also in a wide-angle image in which distortion is included in the image. That is, in the wide-angle image including the fisheye image, the accuracy of object detection may vary depending on the position of the target object in the image.

Therefore, the present disclosure provides a mechanism capable of detecting a target object with higher accuracy regardless of the position of the target object in a wide-angle image.

It is noted that the above-described problem or object is merely one of a plurality of problems or objects that can be solved or achieved by a plurality of embodiments disclosed in the present specification.

### Solution to Problem

An information processing apparatus of the present disclosure includes processing circuitry. The processing circuitry inputs a target area and a distortion intensity of the target area into a trained model, wherein the target area is at least a part of a wide-angle image. The processing circuitry identifies, based on an output of the trained model, a detection target included in the target area.

### BRIEF DESCRIPTION OF DRAWINGS

FIG. 1 is a diagram illustrating an outline of information processing according to an embodiment of the present disclosure.

FIG. 2 is a block diagram illustrating a configuration example of an information processing apparatus according to the embodiment of the present disclosure.

FIG. 3 is a diagram illustrating a detection example of a target area by an area detection unit according to the embodiment of the present disclosure.

FIG. 4 is a diagram illustrating a detection example of a key point by a feature point detection unit according to the embodiment of the present disclosure.

FIG. 5 is a diagram illustrating a calculation example of a distortion intensity by a distortion intensity calculation unit according to the embodiment of the present disclosure.

FIG. 6 is a block diagram illustrating a configuration example of an identification unit according to the embodiment of the present disclosure.

FIG. 7 is a flowchart illustrating an example of a flow of identification processing according to the embodiment of the present disclosure.

FIG. 8 is a block diagram illustrating a configuration example of an information processing apparatus according to a modification of the embodiment of the present disclosure.

FIG. 9 is a block diagram illustrating a configuration example of an identification unit according to the modification of the embodiment of the present disclosure.

FIG. 10 is a flowchart illustrating an example of a flow of identification processing according to the modification of the embodiment of the present disclosure.

FIG. 11 is a diagram illustrating a usage example of an information processing apparatus according to an application example of the embodiment of the present disclosure.

FIG. 12 is a diagram illustrating a configuration example of the information processing apparatus according to the application example of the embodiment of the present disclosure.

FIG. 13 is a hardware configuration diagram illustrating an example of a computer that implements functions of the information processing apparatus according to the present disclosure.

FIG. 14 is a diagram illustrating an example of training and using a machine learning model in connection with image processing in accordance with embodiments of the present disclosure.

### DESCRIPTION OF EMBODIMENTS

Hereinafter, embodiments of the present disclosure will be described in detail with reference to the accompanying drawings. It is noted that, in the present specification and the drawings, components having substantially the same functional configuration are denoted by the same reference numerals, and redundant description is omitted.

Furthermore, in the present specification and the drawings, similar components of the embodiments may be distinguished by adding different alphabets or numbers after the same reference numerals. However, in a case where it is not necessary to particularly distinguish each of similar components, only the same reference numeral is assigned.

One or more embodiments (including examples, modifications, and application examples) described below can each be implemented independently. On the other hand, at least some of the plurality of embodiments described below may be appropriately combined with at least some of other embodiments to be implemented. The plurality of embodiments may include novel features different from each other. Therefore, the plurality of embodiments can contribute to solving different objects or problems, and can exhibit different effects.

Hereinafter, an image captured using a wide-angle lens or an ultra-wide-angle lens such as a fisheye lens will be referred to as a wide-angle image. In addition, an image captured using a normal lens that is not the wide-angle lens or the ultra-wide-angle lens is referred to as a normal image. The wide-angle image is an image having larger distortion than that of the normal image. As described above, in the present specification, the wide-angle image includes a fisheye image captured with a fisheye lens unless otherwise specified.

### 1. Introduction

In recent years, image recognition using a recognition device has been widely performed. For example, in a case of performing image recognition on a normal image having little (small) distortion, an information processing apparatus cuts out a target area including a recognition target (for example, a face, a person, or the like) from the normal image, and inputs the cut target area to the recognition device.

On the other hand, in a case of performing image recognition on a wide-angle image having large distortion, the information processing apparatus cuts out a target area from the wide-angle image, then performs distortion correction processing on the target area, and inputs the target area after the correction processing to the recognition device.

Alternatively, the information processing apparatus generates a planar image by performing distortion correction processing on a wide-angle image, cuts out a target area from the planar image, and inputs the target area to the recognition device.

As described above, in a case where the conventional information processing apparatus performs image recognition on a wide-angle image, it is necessary to perform preprocessing such as distortion correction on the wide-angle image.

Here, the distortion of a wide-angle image varies depending on the position in the image. Therefore, even if distortion correction processing is performed on a wide-angle image, it may be difficult to obtain a correction effect depending on the position in the image. For example, in the case of a fisheye image, the effect of distortion correction is easily obtained in the peripheral area, but the effect of distortion correction is hardly obtained in the central area.

As described above, depending on the algorithm of the distortion correction processing, the effect of the distortion correction in the image may vary. If the effect of the distortion correction processing varies, variations in image recognition accuracy after the correction processing may occur. In addition, image recognition of a wide-angle image has a larger processing load due to the distortion correction processing than that of image recognition of a normal image.

### 1.1. Overview of Information Processing

Therefore, information processing according to the proposed technology of the present disclosure performs image recognition on a wide-angle image without performing distortion correction processing.

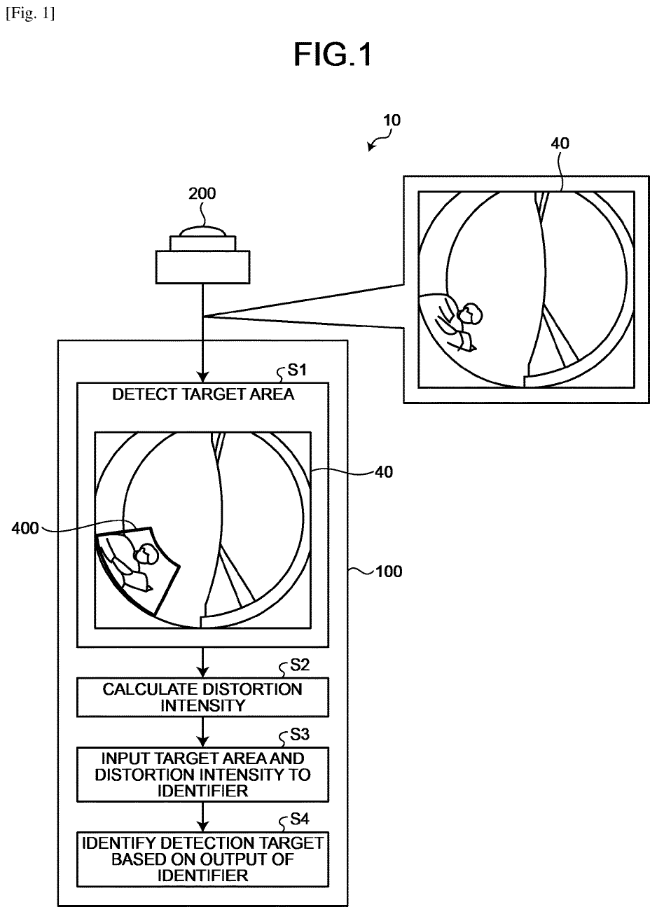

FIG. 1 is a diagram illustrating an outline of information processing according to an embodiment of the present disclosure. The information processing illustrated in FIG. 1 is executed by an information processing apparatus 10. The information processing apparatus 10 includes a control unit 100 and an imaging unit 200.

The imaging unit 200 is, for example, a camera including a fisheye lens, and captures a fisheye image 40. The imaging unit 200 outputs the captured fisheye image 40 to the control unit 100.

The control unit 100 recognizes a detection target (a person in this case) from the fisheye image 40. First, the control unit 100 detects a target area 400 including the person from the fisheye image 40 (step S1).

Next, the control unit 100 calculates a distortion intensity of the target area 400 (step S2). Here, the distortion intensity is an index indicating a degree of distortion of the target area 400. For example, as distortion is larger (big), distortion intensity is higher.

The control unit 100 inputs the target area 400 and the distortion intensity to an identifier (step S3). The control unit 100 identifies (recognizes) a person as the detection target based on the output of the identifier (step S4).

As described above, the information processing apparatus 10 according to the present proposed technology does not perform distortion correction and inputs the calculated distortion intensity to the identifier together with the target area 400. As a result, the information processing apparatus 10 can perform image recognition (here, identification of a person) according to the distortion of the target area. The information processing apparatus 10 can more highly detect a target object regardless of the position of the target object in a fisheye image.

### 2. Configuration Example of Information Processing Apparatus

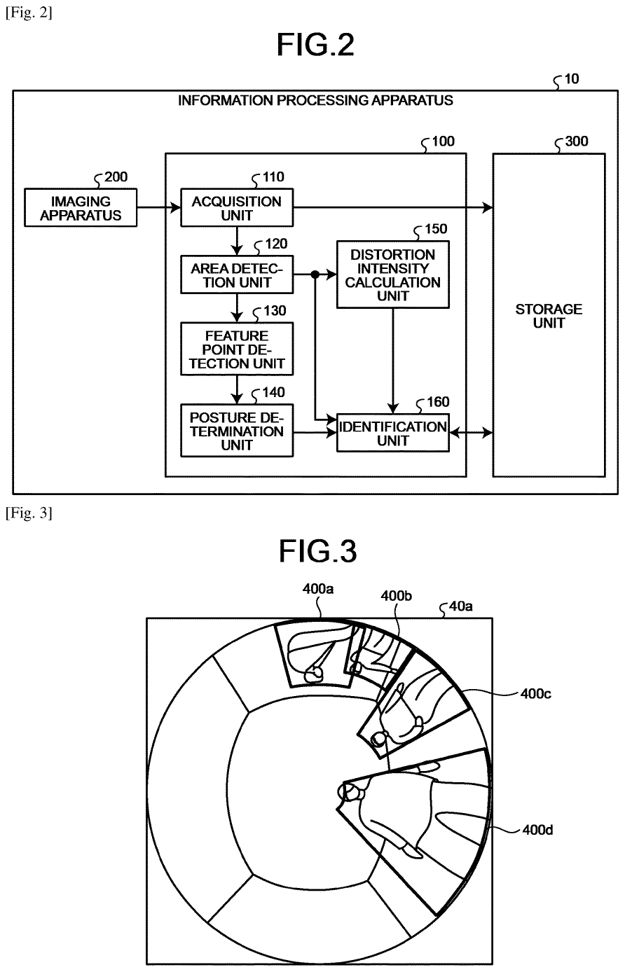

FIG. 2 is a block diagram illustrating a configuration example of the information processing apparatus 10 according to the embodiment of the present disclosure. The information processing apparatus 10 illustrated in FIG. 2 includes the control unit 100, the imaging unit 200, and a storage unit 300.

Here, a description will be given as to a case in which the information processing apparatus 10 having an imaging function performs information processing. The information processing accompanied by the image recognition is performed by the information processing apparatus 10 on the edge side, thereby making it possible to protect the privacy of a person who is a recognition target. It is noted that at least some of the functions of the information processing apparatus 10 may be processed by one or more apparatuses such as a cloud server via a network.

### Imaging Unit 200

The imaging unit 200 is a camera including a wide-angle lens (not illustrated) such as a fisheye lens. The imaging unit 200 captures a moving image or a still image. The imaging unit 200 captures the fisheye image 40 and outputs the fisheye image to the control unit 100.

### Storage Unit 300

The storage unit 300 is a data readable/writable storage device such as a dynamic random access memory (DRAM), a static random access memory (SRAM), a flash memory, or a hard disk. The storage unit 300 stores, for example, the fisheye image 40 captured by the imaging unit 200. The storage unit 300 stores information on an identifier used by the control unit 100.

### Control Unit 100

The control unit 100 is a controller, and is implemented by, for example, a central processing unit (CPU), a micro processing unit (MPU), a graphics processing unit (GPU), or the like executing various programs stored in the storage unit 300 using a RAM as a work area. Furthermore, the control unit 100 can be implemented by, for example, an integrated circuit such as an application specific integrated circuit (ASIC) or a field programmable gate array (FPGA).

The control unit 100 includes an acquisition unit 110, an area detection unit 120, a feature point detection unit 130, a posture determination unit 140, a distortion intensity calculation unit 150, and an identification unit 160, and implements or executes a function and an action of information processing described below.

### Acquisition Unit 110

The acquisition unit 110 acquires the fisheye image 40 from the imaging unit 200. The acquisition unit 110 outputs the acquired fisheye image 40 to the area detection unit 120. The acquisition unit 110 may store the acquired fisheye image 40 in the storage unit 300.

### Area Detection Unit 120

The area detection unit 120 detects the target area 400 from the fisheye image 40. The target area 400 is, for example, a bounding box including an identification target (here, a person) of the information processing apparatus 10. The area detection unit 120 can detect the target area 400 using an existing technique such as machine learning.

FIG. 3 is a diagram illustrating a detection example of the target area 400 by the area detection unit 120 according to the embodiment of the present disclosure. In FIG. 3, the area detection unit 120 detects target areas 400a to 400d included in a fisheye image 40a. As described above, in a case where a plurality of persons (identification targets) are included in the fisheye image 40a, the area detection unit 120 detects a plurality of target areas 400 each including each of the plurality of persons.

In the case of a normal image, the target area (bounding box) 400 is rectangular. On the other hand, in the case of the fisheye image 40, the target area 400 has a fan shape or a circular shape. As described above, in the case of the wide-angle image, the target area 400 has a distorted shape.

Referring back to FIG. 2, the area detection unit 120 outputs the detected target area 400 to the feature point detection unit 130, the distortion intensity calculation unit 150, and the identification unit 160.

### Feature Point Detection Unit 130

The feature point detection unit 130 detects a feature point (a key point) of a person included in the target area 400. The feature point detection unit 130 detects, for example, a shoulder, an elbow, a wrist, a waist, a knee, an ankle, and the like of a person as a key point. The feature point detection unit 130 can detect a key point using an existing technique such as machine learning.

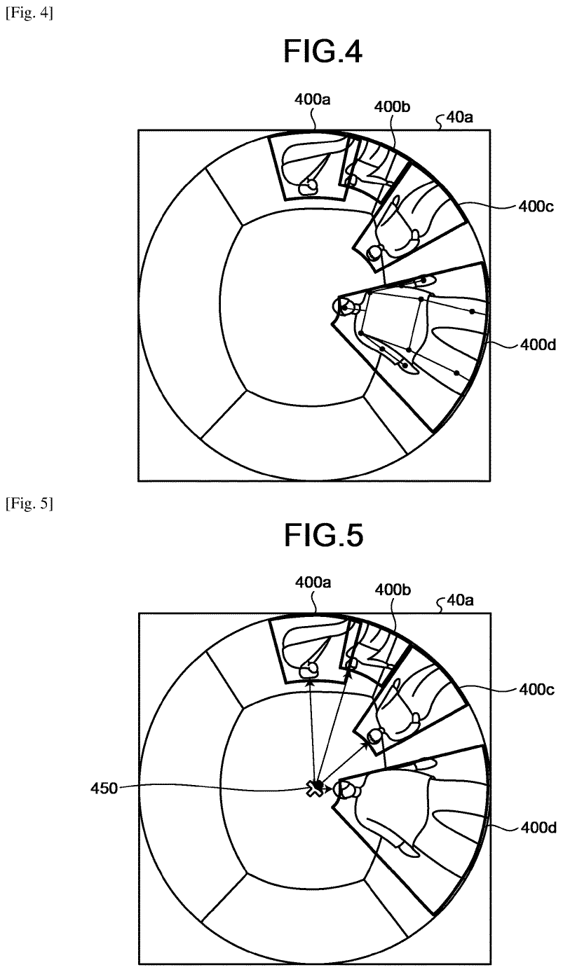

FIG. 4 is a diagram illustrating a detection example of a key point by the feature point detection unit 130 according to the embodiment of the present disclosure. FIG. 4 illustrates a detection example of a key point of a person included in the target area 400d. Here, the key point included in the target area 400d is illustrated, but the feature point detection unit 130 can similarly detect a key point included in the target areas 400a to 400c.

Referring back to FIG. 2, the feature point detection unit 130 outputs the detected key point to the posture determination unit 140.

Here, the control unit 100 detects the detection of the target area 400 and the detection of the key point with different components (for example, different detectors), but the method of detecting the target area 400 and the key point is not limited thereto. For example, the control unit 100 may detect both the target area 400 and the key point using one component (for example, one detector).

### Posture Determination Unit 140

The posture determination unit 140 determines a posture of the person included in the target area 400 based on the key point. The posture determination unit 140 determines whether or not to identify the person according to the determined posture.

For example, in a case where it is difficult to perform identification such as a case where a person as an identification target faces rearwards, the posture determination unit 140 determines not to identify the person.

In a case where the feature point detection unit 130 detects a face part such as an eye or a nose as a key point, the posture determination unit 140 may perform posture determination or determination of necessity of identification according to whether or not the detected key point includes a face part.

The posture determination unit 140 outputs information indicating whether or not to perform identification (necessity of identification) to the identification unit 160.

### Distortion Intensity Calculation Unit 150

The distortion intensity calculation unit 150 calculates a distortion intensity according to the target area 400. The distortion intensity is an index indicating a degree of distortion of the target area 400. For example, the target area 400 is distorted as the distortion intensity increases.

FIG. 5 is a diagram illustrating a calculation example of the distortion intensity by the distortion intensity calculation unit 150 according to the embodiment of the present disclosure.

The distortion intensity calculation unit 150 calculates the distortion intensity of the target area 400 according to a distance from a reference 450. In the case of the fisheye image 40a, the reference 450 is the image center (optical axis). For example, in the case of a wide-angle image in which both sides of the image are distorted, the reference 450 is the central vertical axis of the image. In this manner, the reference 450 is at a position (for example, a point, a line, or the like) depending on how the wide-angle image is distorted.

For example, the distortion intensity calculation unit 150 calculates the distortion intensity according to a distance between the reference 450 located at the image center and the target area 400. For example, the distortion intensity calculation unit 150 calculates a higher distortion intensity as the distance between the reference 450 and the target area 400 is smaller.

In the example of FIG. 5, the distortion intensity of the target area 400d is the highest, and the distortion intensity of the target area 400b is the lowest. In other words, the distortion intensity decreases toward the periphery of the fisheye image 40a, and the distortion intensity increases toward the center thereof.

Alternatively, the distortion intensity calculation unit 150 can calculate the distortion intensity according to the shape (for example, the size) of the target area 400. For example, the target area 400a and the target area 400b are located at the periphery of the fisheye image 40a, but the target area 400a is larger than the target area 400b. In this case, the target area 400a having a larger size has larger distortion than that of the target area 400b.

Therefore, the distortion intensity calculation unit 150 calculates the distortion intensity according to the shape (for example, the length and area of the side (arc)) of the target area 400. For example, the distortion intensity calculation unit 150 calculates a higher distortion intensity as the shape (for example, the length and area of the side (arc)) of the target area 400 is larger.

The distortion intensity calculation unit 150 calculates the distortion intensity based on, for example, a mathematical formula or a table in which the target area 400 and the distortion intensity are associated with each other. The mathematical formula and the table are stored in the storage unit 300 in advance.

Referring back to FIG. 2, the distortion intensity calculation unit 150 outputs the calculated distortion intensity to the identification unit 160.

Here, the distortion intensity calculation unit 150 calculates one distortion intensity for one target area 400, but the distortion intensity calculation unit 150 may calculate a plurality of distortion intensities for one target area 400.

For example, the distortion intensity calculation unit 150 can calculate the distortion intensity for each key point. For example, the distortion intensity calculation unit 150 calculates the distortion intensity according to a distance between the key point and the reference 450 and a shape of the area (for example, a bounding box indicating the face, the torso, or the like) corresponding to the key point (such as the length and area of the side (arc)). The distortion intensity calculation unit 150 may calculate one distortion intensity at one key point or may calculate one distortion intensity at a plurality of key points (for example, eyes, nose, mouth, and the like).

For example, how the face is distorted varies depending on whether the face of a person is located at the periphery or at the center of the fisheye image 40a. As described above, depending on the position of a key point, the manner of distortion (distortion intensity) may be different for each key point. Therefore, the distortion intensity calculation unit 150 may calculate the distortion intensity for each key point. Alternatively, the distortion intensity calculation unit 150 may calculate the distortion intensity at a specific key point important for identification of a person, such as the face, in addition to the distortion intensity of the target area 400.

Furthermore, the distortion intensity calculation unit 150 may calculate the distortion intensity using other information in addition to (or instead of) the fisheye image 450. For example, the distortion intensity calculation unit 150 can acquire an inclination of the imaging unit 200 and an imaging location thereof (position information of the imaging unit 200) from an inertial measurement unit (IMU) or the like and estimate the distortion intensity from these pieces of information.

### Identification Unit 160

When the posture determination unit 140 determines to identify a person, the identification unit 160 identifies a person included in the target area 400. For example, when identification information (ID) is allocated in advance to a person who is an identification target, the identification unit 160 identifies the person by determining identification information corresponding to the person included in the target area 400. When the person included in the target area 400 is a person to be identified for the first time, the identification unit 160 may allocate new identification information to this person.

The identification unit 160 acquires, for example, information regarding an identification target and information regarding an authenticator (an example of an identifier) to be described later from the storage unit 300. The identification unit 160 identifies the detection target using the acquired information.

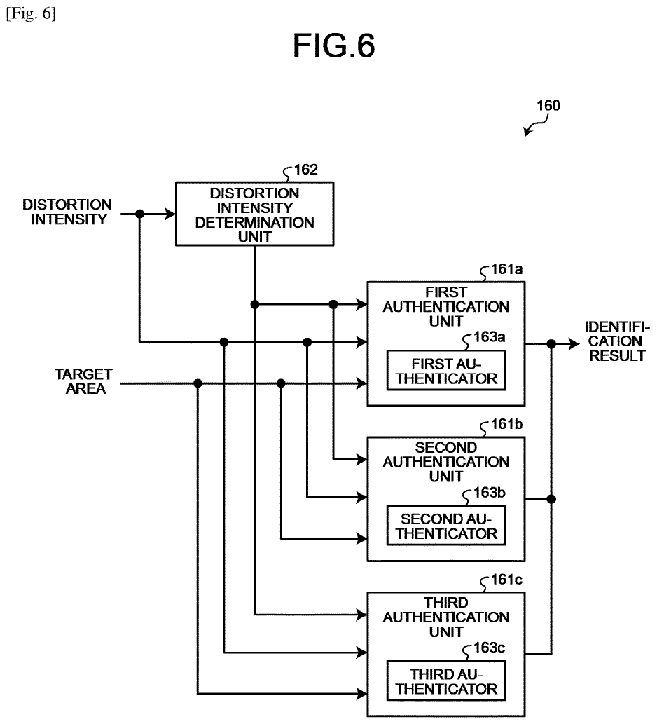

FIG. 6 is a block diagram illustrating a configuration example of the identification unit 160 according to the embodiment of the present disclosure. The identification unit 160 in FIG. 6 includes first to third authentication units 161a to 161c and a distortion intensity determination unit 162.

The first authentication unit 161a includes a first authenticator 163a. The first authenticator 163a is a learned model learned to identify the target area 400 having a high distortion intensity. The first authentication unit 161a identifies a person included in the target area 400 having a high distortion intensity (for example, having a distortion intensity greater than a first intensity threshold value).

The second authentication unit 161b includes a second authenticator 163b. The second authenticator 163b is a learned model learned to identify the target area 400 having a medium distortion intensity. The second authentication unit 161b identifies a person included in the target area 400 having a medium distortion intensity (for example, having a distortion intensity equal to or less than the first intensity threshold value and greater than a second intensity threshold value).

The third authentication unit 161c includes a third authenticator 163c. The third authenticator 163c is a learned model learned to identify the target area 400 having a low distortion intensity. The third authentication unit 161c identifies a person included in the target area 400 having a low distortion intensity (for example, having a distortion intensity less than or equal to the second intensity threshold value).

When the first to third authentication units 161a to 161c are not distinguished from each other, the same are simply referred to as an authentication unit 161. When the first to third authenticators 163a to 163c are not distinguished from each other, the same are simply referred to as an authenticator 163.

The above-described authenticator 163 receives the distortion intensity and the target area 400 as inputs, and outputs an identification result. The authenticator 163 may output at least one of the distortion intensity and the reliability in addition to the identification result. The authenticator 163 outputs, for example, identification information corresponding to a person as the identification result.

As described above, the authenticator 163 may output the reliability of the identification result. The authenticator 163 may estimate the distortion intensity of the target area 400 and output an estimation result. When the authenticator 163 outputs the distortion intensity, the information processing apparatus 10 can recognize a difference from the distortion intensity calculated by the distortion intensity calculation unit 150.

For example, in a case where there is a predetermined difference or more between these distortion intensities, the information processing apparatus 10 can determine that the authentication accuracy of the authenticator 163 has deteriorated. In this case, the information processing apparatus 10 may determine relearning of the authenticator 163.

In this manner, the authenticator 163 calculates the distortion intensity of the target area 400, whereby the information processing apparatus 10 can confirm the accuracy of the identification result and the necessity of relearning.

Here, the authenticator 163 is, for example, a model of a neural network generated by learning. The authenticator 163 is generated by supervised learning for each distortion intensity using, for example, a data set in which the target area 400 and the distortion intensity are associated with each other.

The authentication unit 161 identifies a person included in the target area 400 using the learned authenticator 163.

The authentication unit 161 stores, for example, the identification result in the storage unit 300. Alternatively, the authentication unit 161 may present the identification result to a user via a display device (not illustrated).

The distortion intensity determination unit 162 determines which authentication unit 161 performs identification according to the distortion intensity of the target area 400.

For example, in a case where the distortion intensity is equal to or higher than the first intensity, the distortion intensity determination unit 162 determines that the distortion intensity is high. In this case, the distortion intensity determination unit 162 instructs the first authentication unit 161a to perform identification.

For example, in a case where the distortion intensity is lower than the first intensity and equal to or higher than the second intensity, the distortion intensity determination unit 162 determines that the distortion intensity is a medium degree. In this case, the distortion intensity determination unit 162 instructs the second authentication unit 161b to perform identification.

For example, in a case where the distortion intensity is lower than the second intensity, the distortion intensity determination unit 162 determines that the distortion intensity is low. In this case, the distortion intensity determination unit 162 instructs the third authentication unit 161c to perform identification.

Here, the identification unit 160 identifies a person using the three authenticators 163, but the number of authenticators 163 is not limited to three. The identification unit 160 may identify a person according to the distortion intensity using a plurality of authenticators 163, and the number of authenticators 163 may be two or four or more.

In addition, here, the distortion intensity determination unit 162 selects the authentication unit 161 to perform identification based on the first and second intensities, but the selection method by the distortion intensity determination unit 162 is not limited thereto. For example, in a case where the distortion intensity calculation unit 150 generates information indicating a degree of distortion (for example, “large”, “medium”, “small”, and the like) as the distortion intensity, the distortion intensity determination unit 162 selects the authentication unit 161 based on this information.

### 3. Identification Processing Example

The information processing apparatus 10 executes identification processing for identifying a person as information processing.

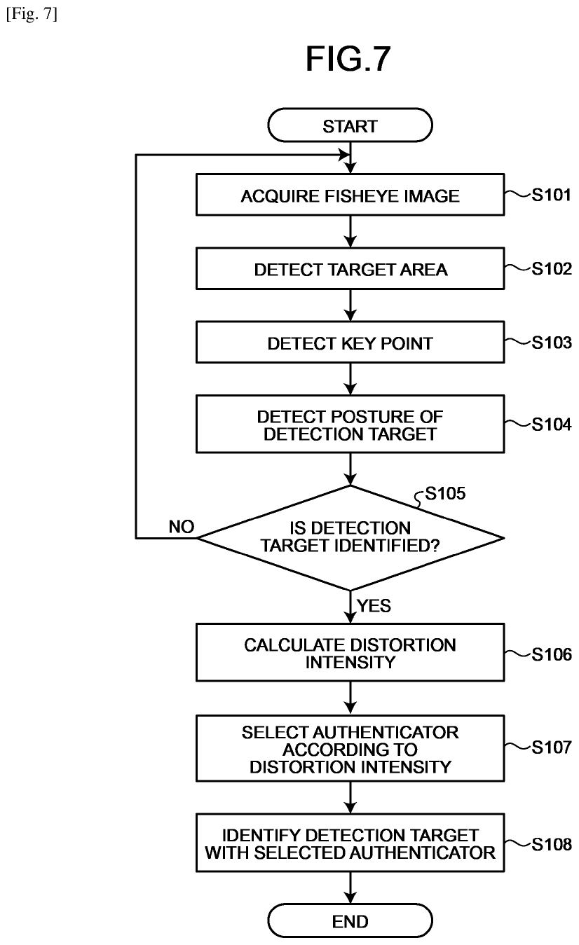

FIG. 7 is a flowchart illustrating an example of a flow of identification processing according to the embodiment of the present disclosure. The identification processing illustrated in FIG. 7 is repeatedly executed by the control unit 100 until capturing ends, for example, in a case where capturing by the imaging unit 200 is started.

As illustrated in FIG. 7, the control unit 100 first acquires the fisheye image 40 (step S101). The control unit 100 detects (extracts) the target area 400 from the fisheye image 40 (step S102). The control unit 100 detects (extracts) a key point from the target area 400 (step S103).

The control unit 100 detects a posture of a detection target (here, a person) based on the key point (step S104). The control unit 100 determines whether or not to identify the detection target according to the detected posture (step S105). The control unit 100 determines whether or not to perform identification according to whether or not the detection target faces rearwards.

When the identification of the detection target is not performed (step S105; No), the control unit 100 returns to step S101 and acquires the fisheye image 40 of the next frame.

On the other hand, in a case where the detection target is identified (step S105; Yes), the control unit 100 calculates a distortion intensity of the target area 400 (step S106). For example, the control unit 100 calculates the distortion intensity according to a distance to the reference 450.

The control unit 100 selects the authenticator 163 to be used for identification according to the distortion intensity (step S107). The control unit 100 identifies the detection target by the selected authenticator 163 (step S108).

As described above, the information processing apparatus 10 according to the present embodiment does not perform correction processing on the target area 400 in a wide-angle image, and identifies the detection target using the distortion intensity of the target area 400. As a result, the information processing apparatus 10 can identify the detection target with higher accuracy regardless of the position of the target area 400 in the wide-angle image.

The information processing apparatus 10 according to the present embodiment identifies the detection target according to the distortion intensity. Therefore, the information processing apparatus 10 can identify the detection target with higher accuracy without depending on a distance or an angle between the detection target and the imaging unit 200.

As described above, the information processing apparatus 10 according to the present embodiment does not perform the correction processing on the wide-angle image. Therefore, the information processing apparatus 10 can further reduce the load of the identification processing. Furthermore, the information processing apparatus 10 can identify the detection target with higher accuracy regardless of the effect of the correction processing.

### 4. Modification

In the embodiment described above, the information processing apparatus 10 identifies a target object using the plurality of authenticators 163 for each distortion intensity. In this case, it is possible to reduce the weight of the processing of each authenticator 163, and the processing load of the identification processing is reduced. Therefore, the identification processing using the plurality of authenticators 163 is useful in a case where the identification processing is completed on the edge side (information processing apparatus 10).

On the other hand, the authentication unit 161 may perform identification using one authenticator 163 regardless of the distortion intensity. In this case, since the processing of the authenticator 163 becomes large, it is more desirable for the cloud side to perform identification processing than for the edge side to perform identification processing. However, by reducing the weight of the authenticator 163 using various weight reduction methods, it is also possible to perform identification using one authenticator 163 on the edge side.

Hereinafter, as a modification according to the present embodiment, an information processing apparatus 10A that performs identification processing using one authenticator 163 will be described.

### 4.1. Configuration Example of Information Processing Apparatus

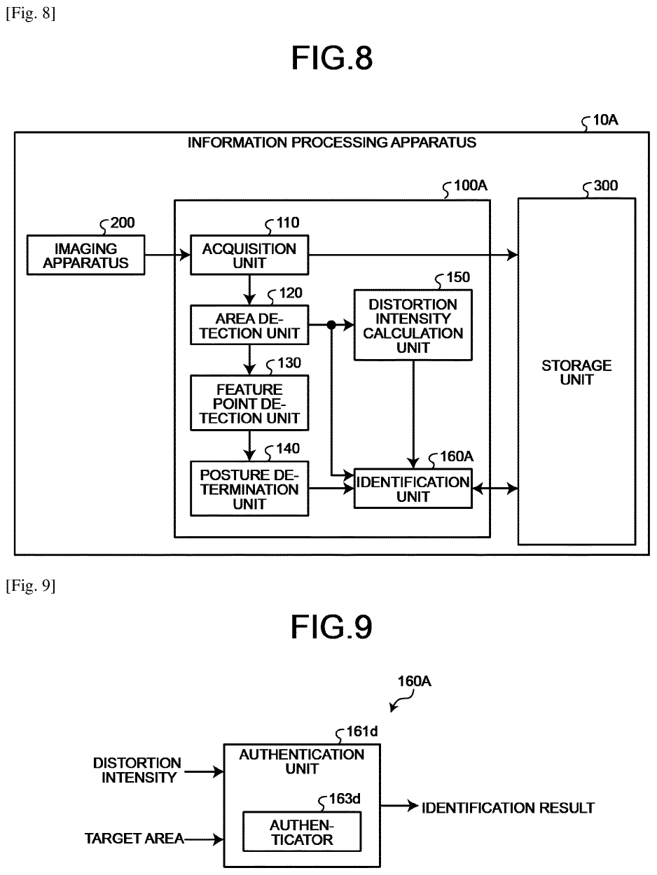

FIG. 8 is a block diagram illustrating a configuration example of the information processing apparatus 10A according to the modification of the embodiment of the present disclosure. The information processing apparatus 10A illustrated in FIG. 8 has the same configuration as that of the information processing apparatus 10 illustrated in FIG. 2 except that a control unit 100A is included. The control unit 100A has the same configuration as that of the control unit 100A illustrated in FIG. 2 except that an identification unit 160A is provided.

When the posture determination unit 140 determines to identify the target area 400, the identification unit 160A identifies a person included in the target area 400. The identification unit 160A performs identification using the distortion intensity and the target area 400.

FIG. 9 is a block diagram illustrating a configuration example of the identification unit 160A according to the modification of the embodiment of the present disclosure. The identification unit 160A in FIG. 9 includes an authentication unit 161d. As described above, the identification unit 160A is different from the identification unit 160 illustrated in FIG. 6 in that one authentication unit 161d is provided.

The authentication unit 161d inputs the distortion intensity and the target area 400 to an authenticator 163d, and acquires an identification result from the authenticator 163d. The authenticator 163d is a learned model learned to identify the target area 400 for all the distortion intensities. The authentication unit 161d identifies the person included in the target area 400 regardless of the distortion intensity.

The authenticator 163d outputs, for example, identification information corresponding to a person as the identification result. The authenticator 163d may output the reliability and the distortion intensity in addition to the identification result.

Here, the authenticator 163d is, for example, a model of a neural network generated by learning. The authenticator 163d is generated by supervised learning without distinguishing the distortion intensities using, for example, a data set in which the target area 400 and the distortion intensity are associated with each other.

It is noted that the operation of the authentication unit 161d may be the same as that of the authentication unit 161 in FIG. 6 except that one authenticator 163d is used.

### 4.2. Identification Processing Example

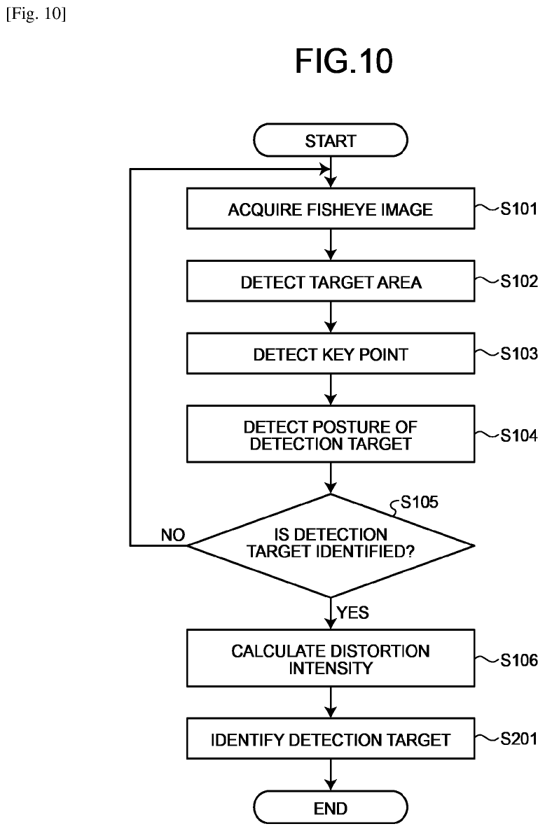

FIG. 10 is a flowchart illustrating an example of a flow of identification processing according to the modification of the embodiment of the present disclosure. In the processing illustrated in FIG. 10, the same processing as that of FIG. 7 is denoted by the same reference numeral, and a description thereof is omitted.

The control unit 100A that has calculated the distortion intensity in step S106 identifies the detection target using one authenticator 163d (step S201). The control unit 100A inputs the distortion intensity and the target area 400 to the authenticator 163d. The control unit 100A identifies a person as a detection target based on the output of the authenticator 163d.

As described above, in the present modification, the information processing apparatus 10A identifies the detection target using one authenticator 163d. As a result, the information processing apparatus 10A can obtain an effect similar to that of the information processing apparatus 10 according to the embodiment, and can omit the processing of selecting the authenticator 163 according to the distortion intensity.

### 5. Application Example

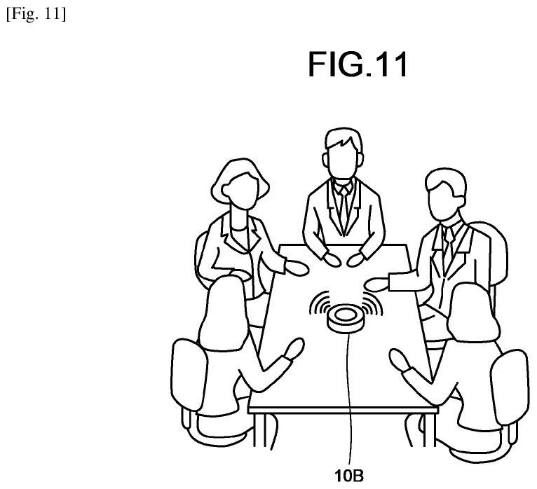

FIG. 11 is a diagram illustrating a usage example of an information processing apparatus 10B according to an application example of the embodiment of the present disclosure. For example, the information processing apparatus 10B executes an utterance identification application. The technology of the present disclosure can be used to identify a speaker.

For example, the information processing apparatus 10B determines who is speaking to what extent when a conference is held. In this case, the information processing apparatus 10 is installed at the center of the desk at which attendees of the conference are seated. The information processing apparatus 10B calculates the number of utterances, the utterance time, and the like of each attendee.

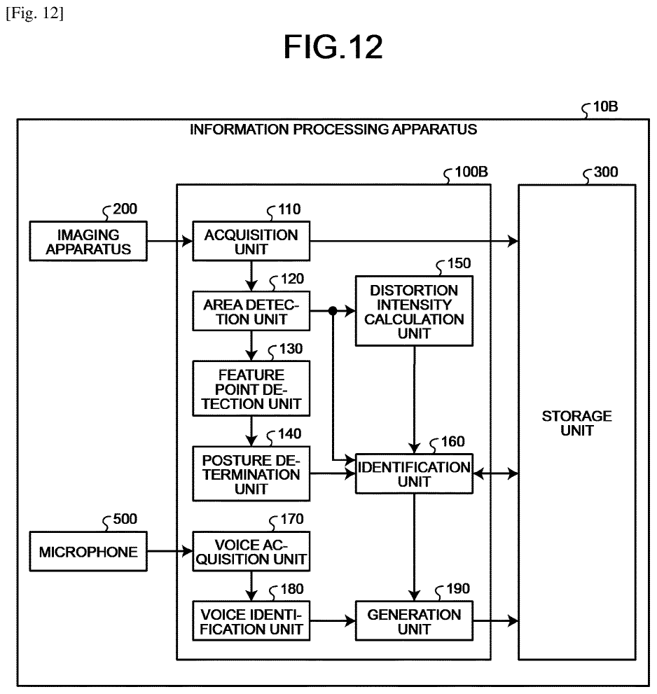

FIG. 12 is a diagram illustrating a configuration example of the information processing apparatus 10B according to the application example of the embodiment of the present disclosure. The information processing apparatus 10B illustrated in FIG. 12 has the same configuration as that of the information processing apparatus 10 illustrated in FIG. 2 except that a microphone 500 is provided and that a control unit 100B includes a voice acquisition unit 170, a voice identification unit 180, and a generation unit 190.

The microphone 500 collects sounds (for example, utterance of a conference attendee) around the information processing apparatus 10B. The microphone 500 may be a microphone array device in which a plurality of microphones are arranged. In this case, for example, the information processing apparatus 10B can estimate a direction of a sound source (that is, a speaker) based on the sound (voice) collected by the microphone 500.

The voice acquisition unit 170 acquires a voice collected by the microphone 500. The voice acquisition unit 170 outputs the acquired voice to the voice identification unit 180.

The voice identification unit 180 identifies a voice. The voice identification unit 180 estimates the direction in which the voice is emitted. The voice identification unit 180 may estimate an utterance content and identify a speaker based on the voice.

The generation unit 190 generates utterance information in which the person identified by the identification unit 160 is associated with the utterance identified by the voice identification unit 180. The utterance information may include, for example, a person, the number of utterances, and an utterance time. Furthermore, the utterance information may include an utterance content of a person.

The generation unit 190 stores the utterance information in the storage unit 300. Alternatively, the generation unit 190 causes a display device (not illustrated) to display the utterance information.

The information processing apparatus 10B can identify a person (here, a conference attendee) with higher accuracy without performing correction processing. Therefore, the information processing apparatus 10B can further improve utterance identification performance.

### 6. Other Embodiments

The processing according to the above-described embodiment and modification may be performed in various different modes other than the above-described embodiment and modification.

For example, in the above-described embodiment and modification, the information processing apparatus 10 or the like identifies the detection target included in the target area 400, but the information processing apparatus 10 or the like may further perform attribute identification of the detection target included in the target area 400.

For example, in a case where the entire body of a person as a detection target is included in the target area 400, the information processing apparatus 10 or the like can identify the attribute of the person from clothes, hairstyle, and the like. In this case, the information processing apparatus 10 or the like may perform attribute identification using an identifier corresponding to the attribute to be identified (for example, gender, age, and the like). The information processing apparatus 10 or the like may divide and identify the target area 400 according to a portion of a person (for example, the head, the torso, or the like). The information processing apparatus 10 or the like may perform the attribute identification after correcting the distortion of the target area 400.

For example, in the above-described embodiment and modification, a description has been given, as an example, as to a case in which the information processing apparatus 10 or the like performs the identification processing on the fisheye image 40, but the information processing apparatus 10 or the like can similarly perform the identification processing on a wide-angle image other than the fisheye image 40. As a result, the information processing apparatus 10 or the like can identify the detection target with higher accuracy regardless of the type of the wide-angle lens.

Furthermore, in the embodiment and the modification described above, the information processing apparatus 10 or the like includes the imaging unit 200, but the information processing apparatus 10 or the like may not include the imaging unit 200. In this case, for example, the information processing apparatus 10 or the like acquires a wide-angle image captured by an imaging apparatus (for example, a camera) having a function of the imaging unit 200 from the imaging apparatus. The information processing apparatus 10 or the like identifies the detection target from the acquired wide-angle image.

### 7. Hardware Configuration

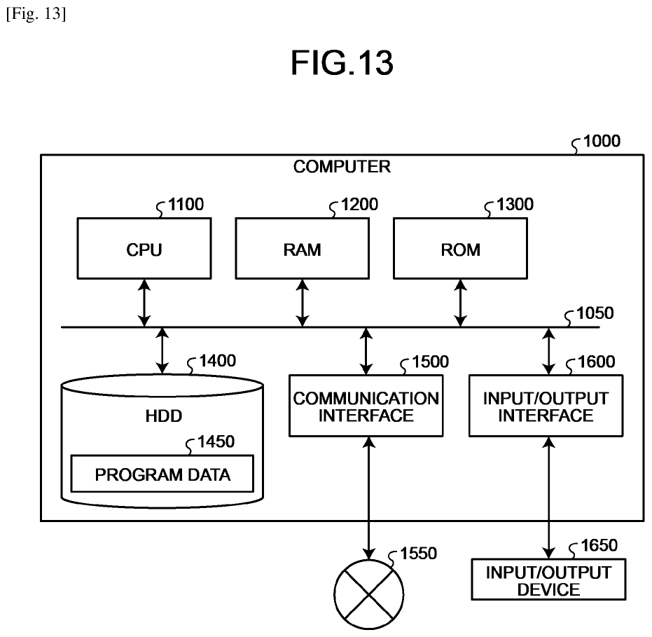

An apparatus such as the information processing apparatus 10 according to the present disclosure described above is implemented by, for example, a computer 1000 having a configuration as illustrated in FIG. 13. FIG. 13 is a hardware configuration diagram illustrating an example of the computer 1000 that implements the functions of the information processing apparatus 10 according to the present disclosure. Hereinafter, the information processing apparatus 10 according to the embodiment will be described as an example of the computer 1000. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 loads the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is started, a program dependent on the hardware of the computer 1000, and the like.

The HDD 1400 is a recording medium readable by the computer 1000 that non-transiently records programs executed by the CPU 1100, data used by the programs, and the like. Specifically, the HDD 1400 is a recording medium that records an image processing program according to the present disclosure as an example of program data 1450.

The communication interface 1500 is an interface configured to allow the computer 1000 to be connected to an external network 1550 (for example, the Internet). For example, the CPU 1100 receives data from another device or transmits data generated by the CPU 1100 to another device via the communication interface 1500.

The input/output interface 1600 is an interface configured to connect an input/output device 1650 to the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface configured to read a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10 according to the embodiment, the CPU 1100 of the computer 1000 implements the function of the control unit 100 by executing an information processing program loaded in the RAM 1200. In addition, the HDD 1400 stores an information processing program according to the present disclosure and data in the storage unit 300. It is noted that the CPU 1100 reads the program data 1450 from the HDD 1400 and executes the program data, but as another example, these programs may be acquired from another device via the external network 1550.

### 8. Summary

Although the embodiments of the present disclosure have been described above, the technical scope of the present disclosure is not limited to the above-described embodiments as it is, and various modifications can be made without departing from the gist of the present disclosure. In addition, components of the embodiment and the modification may be appropriately combined.

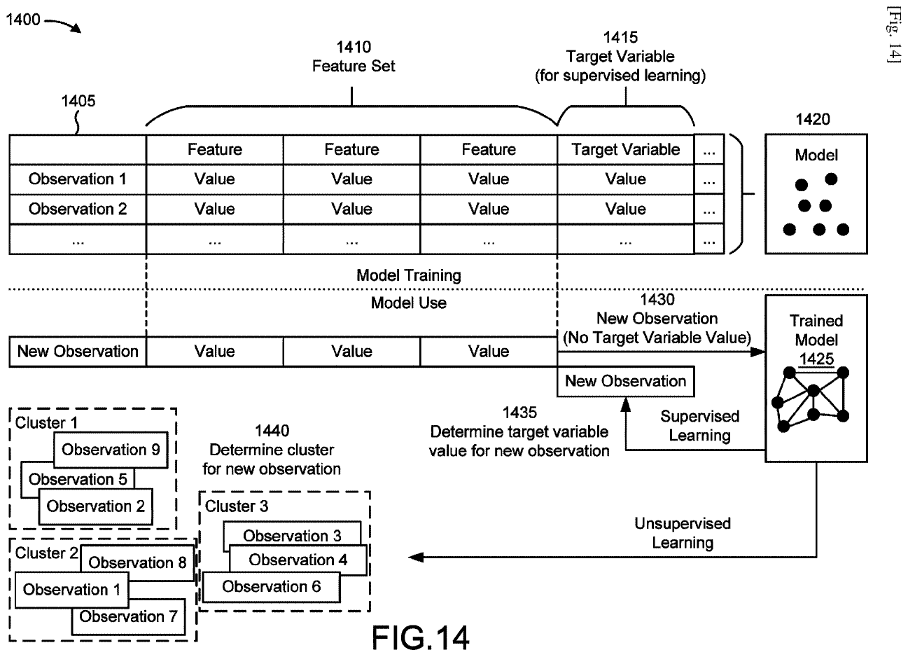

FIG. 14 is a diagram illustrating an example 1400 of training and using a machine learning model in connection with computer vision and/or image processing (e.g., object detection, facial recognition, and/or image segmentation, among other examples). This machine learning model may be used to identify a person using a distorted image (e.g., image from a wide-angle lens such as a fisheye lens) as input in accordance with embodiments of the disclosure outlined above. The machine learning model training and usage described herein may be performed using a machine learning system. The machine learning system may include, or may be included in, a computing device, a server, and/or a cloud computing environment, among other examples, such as the image processing system, as described in more detail elsewhere herein.

As shown by reference number 1405, a machine learning model may be trained using a set of observations. The set of observations may be obtained from training data (e.g., historical visual observation data associated with visual records and/or image data), such as data gathered during one or more processes described herein. In some implementations, the machine learning system may receive the set of observations (e.g., as input) from the image processing system, as described elsewhere herein.

As shown by reference number 1410, the set of observations (e.g., visual observation data) may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the image processing system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include features of distortion intensity, color distribution, texture features, shape descriptors, edge features, corner features, object sizes, area proportions, orientations, aspect ratios, /d/ or color dominance, among other examples. As shown, for a first observation, the features may have values of color histogram values, texture attribute values, shape moment values, edge response values, corner response values, object size values, area proportion values, orientation values, aspect ratio values, color dominance values, /d/ or gradient magnitudes, among other examples. These features and feature values are provided as examples and may differ in other examples.

As shown by reference number 1415, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, and/or labels, among other examples) and/or may represent a variable having a Boolean value. A target variable may be associated with a target variable value, and a target variable value may be specific to an observation. In example 1400, the target variable may be an object category (e.g., associated with identifying the category or type of an object in an image), emotion recognition (e.g., associated with predicting the emotion expressed in a facial image), segmentation mask (e.g., associated with generating pixel-level segmentation masks to outline and classify different regions or objects in an image), pose estimation (e.g., associated with predicting the pose or orientation of an object in an image), image quality assessment (e.g. associated with estimating the quality of an image), anomaly detection (e.g., associated with identifying unusual or anomalous regions in an image), image captioning (e.g., associated with generating descriptive captions or textual explanations for the content of an image), age estimation (e.g., associated with predicting an age of individuals depicted in an image), optical character recognition (OCR) (e.g., associated with recognizing and extracting text from images, image similarity (e.g., associated with calculating similarity scores between images to group similar images together), among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 1420, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 1425 to be used to analyze new observations.

As an example, the machine learning system may obtain training data for the set of observations based on image preprocessing techniques, as described in more detail elsewhere herein.

As shown by reference number 1430, the machine learning system may apply the trained machine learning model 1425 to a new observation (e.g., a new visual observation), such as by receiving a new observation and inputting the new observation to the trained machine learning model 1425. In the context of image processing, a new observation may include features of image pixel values, edge maps, among other examples). The machine learning system may apply the trained machine learning model 1425 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 1425 may predict a value of tree for the target variable of “type of object present in an image” for the new observation, as shown by reference number 1435. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a suggested object category of tree. The first automated action may include, for example, classifying the object into an object category of tree.

In some implementations, the trained machine learning model 1425 may classify (e.g., cluster) the new observation in a cluster, as shown by reference number 1440. The observations within a cluster may have a threshold degree of similarity. For example, if the historical records indicate similar image characteristics, then the images likely depict related objects. As an example, if the machine learning system classifies the new observation in a first cluster (e.g., trees), then the machine learning system may provide a first recommendation, such as the first recommendation described above.

As another example, if the machine learning system were to classify the new observation in a second cluster (e.g., a face), then the machine learning system may provide a second (e.g., different) recommendation (e.g., suggest an object category of the face, if desired).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 1425 may be re-trained using feedback information. For example, feedback may be provided to the machine learning model. The feedback may be associated with actions performed based on the recommendations provided by the trained machine learning model 1425 and/or automated actions performed, or caused, by the trained machine learning model 1425. In other words, the recommendations and/or actions output by the trained machine learning model 1425 may be used as inputs to re-train the machine learning model (e.g., a feedback loop may be used to train and/or update the machine learning model). For example, the feedback information may include a correct object category suggestion that is an output from the model.

In this way, the machine learning system may apply a rigorous and automated process to computer vision and/or image processing, as described in more detail elsewhere herein. The machine learning system may enable recognition and/or identification of tens, hundreds, thousands, or millions of features and/or feature values for tens, hundreds, thousands, or millions of observations, thereby increasing accuracy and consistency and reducing delay associated with computer vison and/or image processing relative to requiring computing resources to be allocated for tens, hundreds, or thousands of operators to manually process visual observations and/or images using the features or feature values.

As indicated above, FIG. 14 is provided as an example. Other examples may differ from what is described in connection with FIG. 14.

Furthermore, the effects of each embodiment described in the present specification are merely examples and are not limited, and other effects may be obtained.

It is noted that the present disclosure can also have the following configurations.
(1)

An information processing apparatus, comprising:
processing circuitry configured to
input a target area and a distortion intensity of the target area into a trained model, wherein the target area is at least a part of a wide-angle image; and
identify, based on an output of the trained model, a detection target included in the target area.
(2)

The information processing apparatus according to (1),
wherein the processing circuitry is further configured to
identify the detection target using one of a plurality of trained models, the one of the plurality of trained models being selected according to the distortion intensity.
(3)

The information processing apparatus according to (1),
wherein the processing circuitry is further configured to
identify the detection target using the selected trained model.
(4)

The information processing apparatus according to any one of (1) to (3),
wherein the processing circuitry is further configured to
calculate the distortion intensity according to a distance between the target area and a reference.
(5)

The information processing apparatus according to (4), wherein the reference is a central portion of the wide-angle image.
(6)

The information processing apparatus according to any one of (1) to (5),
wherein the processing circuitry is further configured to
calculate the distortion intensity according to a size of the target area.
(7)

The information processing apparatus according to any one of (1) to (6),
wherein the processing circuitry is further configured to
calculate the distortion intensity for each feature point included in the target area.
(8)

The information processing apparatus according to any one of (1) to (7),
wherein the processing circuitry is further configured to
calculate the distortion intensity using at least one of an inclination of a camera and position information thereof, wherein the camera captures the wide-angle image.
(9)

The information processing apparatus according to any one of (1) to (8), wherein the trained model outputs information on the distortion intensity of the input target area.
(10)

The information processing apparatus according to any one of (1) to (9), wherein the target area has a fan shape.
(11)

The information processing apparatus according to any one of (1) to (10),
wherein the processing circuitry is further configured to
determine whether or not to identify the detection target according to a posture of the detection target included in the target area.
(12)
The information processing apparatus according to any one of (1) to (11), wherein the wide-angle image is a fisheye image captured by a fisheye lens.
(13)

The information processing apparatus according to any one of (1) to (11), wherein the wide-angle image is an image captured by a wide-angle lens.
(14)

The information processing apparatus according to any one of (1) to (13), further comprising:
a camera configured to capture the wide-angle image,
wherein the processing circuitry is further configured to identify the detection target from the wide-angle image captured by the camera.
(15)

The information processing apparatus according to any one of (1) to (14), wherein the processing circuitry is further configured to:
acquire voice information including a voice uttered by the detection target; and
associate the identified detection target with the voice.
(16)

The information processing apparatus according to any of (1) to (15), wherein the trained model is trained using only fisheye images as training data.
(17)

The information processing apparatus according to any of (1) to (16), wherein the trained model is trained using only wide-angle images as training data.
(18)

An information processing method comprising:
inputting a target area and a distortion intensity of the target area into a trained model,
wherein the target area is at least a part of a wide-angle image; and
identifying, based on an output of the trained model, a detection target included in the target area.
(19)

The method of (18), wherein the trained model is trained using only fisheye images as training data.
(20)

A non-transitory computer-readable storage medium having computer-readable instructions stored thereon which, when executed by a computer, cause the computer to perform a method, the method comprising:
inputting a target area and a distortion intensity of the target area into a trained model,
wherein the target area is at least a part of a wide-angle image; and
identifying, based on an output of the trained model, a detection target included in the target area.

### REFERENCE SIGNS LIST

10 Information processing apparatus
100 Control unit
110 Acquisition unit
120 Area detection unit
130 Feature point detection unit
140 Posture determination unit
150 Distortion intensity calculation unit
160 Identification unit
161 Authentication unit
162 distortion intensity determination unit
163 Authenticator
200 Imaging unit
300 Storage unit

1. An information processing apparatus, comprising: processing circuitry configured to
input a target area and a distortion intensity of the target area into a trained model, wherein the target area is at least a part of a wide-angle image; and
identify, based on an output of the trained model, a detection target included in the target area.

2. The information processing apparatus according to claim 1, wherein the processing circuitry is further configured to
identify the detection target using one of a plurality of trained models, the one of the plurality of trained models being selected according to the distortion intensity.

3. The information processing apparatus according to claim 1, wherein the processing circuitry is further configured to identify the detection target using the selected trained model.

4. The information processing apparatus according to claim 1, wherein the processing circuitry is further configured to calculate the distortion intensity according to a distance between the target area and a reference.

5. The information processing apparatus according to claim 4, wherein the reference is a central portion of the wide-angle image.

6. The information processing apparatus according to claim 1, wherein the processing circuitry is further configured to calculate the distortion intensity according to a size of the target area.

7. The information processing apparatus according to claim 1, wherein the processing circuitry is further configured to calculate the distortion intensity for each feature point included in the target area.

8. The information processing apparatus according to claim 1, wherein the processing circuitry is further configured to calculate the distortion intensity using at least one of an inclination of a camera and position information thereof, wherein the camera captures the wide-angle image.

9. The information processing apparatus according to claim 1, wherein the trained model outputs information on the distortion intensity of the input target area.

10. The information processing apparatus according to claim 1, wherein the target area has a fan shape.

11. The information processing apparatus according to claim 1, wherein the processing circuitry is further configured to
determine whether or not to identify the detection target according to a posture of the detection target included in the target area.

12. The information processing apparatus according to claim 1, wherein the wide-angle image is a fisheye image captured by a fisheye lens.

13. The information processing apparatus according to claim 1, wherein the wide-angle image is an image captured by a wide-angle lens.

14. The information processing apparatus according to claim 1, further comprising:
a camera configured to capture the wide-angle image,
wherein the processing circuitry is further configured to identify the detection target from the wide-angle image captured by the camera.

15. The information processing apparatus according to claim 1, wherein the processing circuitry is further configured to:
acquire voice information including a voice uttered by the detection target; and
associate the identified detection target with the voice.

16. An information processing method, comprising:
inputting a target area and a distortion intensity of the target area into a trained model, wherein the target area is at least a part of a wide-angle image; and
identifying, based on an output of the trained model, a detection target included in the target area.

17. A non-transitory computer-readable storage medium having computer-readable instructions stored thereon which, when executed by a computer, cause the computer to perform a method, the method comprising:
inputting a target area and a distortion intensity of the target area into a trained model, wherein the target area is at least a part of a wide-angle image; and
identifying, based on an output of the trained model, a detection target included in the target area.

18. The information processing apparatus according to claim 1, wherein the trained model is trained using only fisheye images as training data.

19. The information processing apparatus according to claim 1, wherein the trained model is trained using only wide-angle images as training data.

20. The method of claim 16, wherein the trained model is trained using only fisheye images as training data.
